(19) United States
(12) Patent Application Publication
(10) Pub. No.: US 2013/0030974 A1
(43) Pub. Date: Jan. 31, 2013

(54) DEVICE AND METHOD FOR AUTOMATICALLY ALLOCATING AND TRANSFERRING FUNDS IN AN ACCOUNT

(71) Applicants: Brendan Casey, Portland, OR (US); Jeff Palmer, Scottsdale, AZ (US); Ken Wilcox, Portola Valley, CA (US); Lauri Moss, Danville, CA (US)

(72) Inventors: Brendan Casey, Portland, OR (US); Jeff Palmer, Scottsdale, AZ (US); Ken Wilcox, Portola Valley, CA (US); Lauri Moss, Danville, CA (US)

(21) Appl. No.: 13/482,835

(22) Filed: May 29, 2012

Related U.S. Application Data
(60) Provisional application No. 61/490,878, filed on May 27, 2011.

(51) Int. Cl. G06Q 40/02; G06Q 40/06

(52) U.S. Cl. 705/37; 705/39

(57) ABSTRACT

A device including a processor which automatically allocates and transfers funds in a sweep account between a primary on-balance demand account and one or more off-balance accounts in a manner which assists the bank in maintaining an optimal liquidity profile and capital structure. The device is adapted to prepare and analyze current data pertaining to the liquidity profile and capital structure of a bank and compare this data to predetermined reference values stored in data storage means of the device. The device has an allocation unit which utilizes an algorithm in order to allocate an amount of funds to transfer between an on-balance account and one or more off-balance accounts which will provide an optimal liquidity profile and capital structure for the bank.

### CROSS REFERENCE TO RELATED APPLICATION

This application claims the benefit of U.S. Provisional Application No. 61/490,878 filed May 27, 2011 and incorporates the same by reference.

### FIELD OF THE INVENTION

This invention relates generally to an automated device for allocating and transferring funds in a sweep account from a primary account to a secondary account.

### BACKGROUND OF THE INVENTION

Regulation Q is a law enacted in 1932 which prohibits a financial institution such as a bank from paying interest on demand deposits such as a checking account held by the bank. In order to offer a more attractive type of deposit account to customers while maintaining compliance with Regulation Q and other applicable rules, banks developed “sweep accounts.” A sweep account is an account comprised of a plurality of different accounts at a financial institution. A common sweep account will hold funds in an on-balance deposit account during the day where the customer is unable to accrue interest on the funds. However, some or all of the funds are transferred overnight into an off-balance investment account, typically at a bank's overseas division, where the funds are able to accrue interest. In addition, the transfer of the funds to an off-balance account often allows the bank to avoid certain fees such as FDIC insurance and provides a comparatively high rate of return.

### SUMMARY OF INVENTION

Regulation Q was recently repealed and banks will be permitted, but not required, to pay interest on checking accounts beginning in July 2011. However, while sweep accounts may not be necessary to provide a customer with interest bearing demand deposits once the repeal is in effect, sweep accounts are expected to remain a popular bank deposit product. More specifically, a sweep account after Regulation Q is no longer in effect will allow a customer to earn interest on on-balance demand accounts, and the bank can exercise greater flexibility with the client's funds. A bank will be able to transfer funds to and from off balance accounts in order to benefit the bank's overnight and general funding needs, and the client's financial goals will still be well served because interest will be earned on the on balance demand account.

A disadvantage of known sweep accounts is that they provide a fixed allocation of the amount of funds that are transferred to off-balance accounts each night. For example, a bank may predetermine that all funds which exceed a set base amount in the demand account is transferred to the off-balance account. Alternatively, a fixed percentage of the funds held in the account may be transferred each day. One problem with this type of system is that there are instances when the capital base of the bank may be severely weakened by transfer of some or all of the funds in a sweep account and there is no system to monitor the effect of the scheduled transfer on the bank's liquidity profile and capital structure or to change the amount of funds transferred. Furthermore, if a bank provides discretion to one or more employees to modify the amount transferred to an off-balance account in a sweep account or vice versa, this discretion poses a significant risk. Due to human error or abuse, an inappropriate amount of funds may be allocated for transfer which could damage the banks liquidity profile, capital structure, and/or present regulatory issues.

Accordingly, in one aspect the present invention provides a device for automatically allocating and transferring funds deposited in a sweep account between a primary on-balance demand account and one or more off-balance accounts in a manner which assists the bank in maintaining an optimal liquidity profile and capital structure.

The present invention also provides a method for automatically allocating and transferring funds deposited in a sweep account between a primary on-balance demand account and one or more off-balance accounts in a manner which assists the bank in maintaining an optimal liquidity profile and capital structure.

The present invention also provides a computer-readable medium storing a program, which, when executed by a processor, automatically allocates and transfers funds deposited in a sweep account between a primary on-balance demand account and one or more off-balance accounts in a manner which assists the bank in maintaining an optimal liquidity profile and capital structure.

In accordance with one aspect of the invention, there is provided a device including a processor which automatically allocates and transfers funds in a sweep account between a primary on-balance demand account and one or more off-balance accounts in a manner which assists the bank in maintaining an optimal liquidity profile and capital structure. The device is adapted to prepare and analyze current data pertaining to the banks liquidity profile and capital structure and compare this data to predetermined reference values stored in a data storage unit of the device. The device has an allocation unit which utilizes an algorithmic formula in order to allocate an amount of funds to transfer between an on-balance account and one or more off-balance accounts which assists the bank in maintaining an optimal liquidity profile and capital structure.

In accordance with another aspect of the invention there is provided a method implemented on a computer having a processor and a data storage unit for allocating and transferring funds in a sweep account between a primary on-balance demand account and one or more off-balance accounts in a manner which assists the bank in maintaining an optimal liquidity profile and capital structure.

In accordance with another aspect of the invention, there is provided a non-transitory computer-readable medium storing a program which, when executed by at least one processor, allocates and transfers funds in a sweep account between a primary on-balance demand account and one or more off-balance accounts in a manner which assists the bank in maintaining an optimal liquidity profile and capital structure.

### BRIEF DESCRIPTION OF THE DRAWINGS

The features and advantages of the present invention will be more readily understood from a detailed description of the exemplary embodiments taken in conjunction with the following figures in which:

FIG. 1 is a block diagram of an example device for allocating and transferring funds deposited in a first account to a second account in accordance with an embodiment of the present invention;

FIG. 2 shows a computer system for implementing the functionality described herein; and

FIG. 3 is a flowchart illustrating a method of the present invention according to one embodiment.

### DETAILED DESCRIPTION OF THE PREFERRED EMBODIMENTS

The present invention is particularly directed to an improved method, program, and device for automatically allocating and transferring funds deposited in a first account to a second account. The method, program, and device are preferably used in connection with a sweep account provided by a bank and serve to automatically allocate and transfer funds between a primary on-balance demand account and one or more off-balance accounts in a manner which assists the bank in maintaining an optimal liquidity profile and capital structure. The term “bank” as used in this application includes all financial institutions which maintain accounts for customers' deposits for purposes including, but not limited to, savings, checking, or investment.

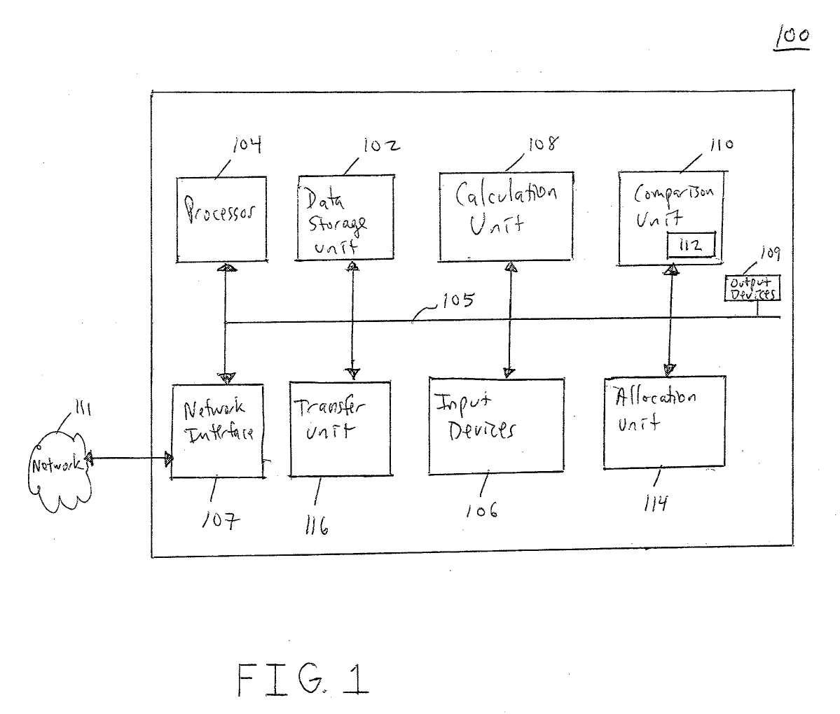

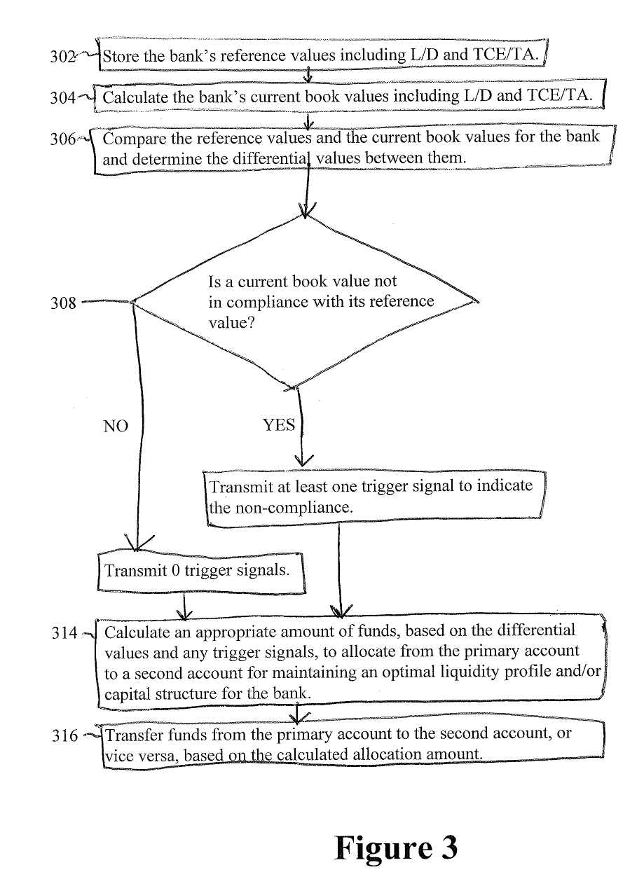

FIG. 1 shows an example of such device 100 comprising a computer including a data storage unit 102 and at least one processor 104. In a preferred embodiment, the device is a personal computer which receives the instructions for allocating and transferring funds via software. However, in alternative embodiments the device may be a standalone computerized device including a data storage unit, a processor, and programmed instructions for allocating and transferring funds. Of course, these are just examples, and the present invention is not limited thereto. FIG. 3 is a flowchart illustrating a method of the present invention according to one embodiment.

The device 100 shown in FIG. 1 has a bus system 105 including, for example, a data bus and a motherboard, which can be used to establish and control data communications between the components 102, 104, 106, 107, 108, 109, 110, 112, 114, and 116. The data storage unit 102 receives the reference values (see, e.g., step 302 of FIG. 3). The network interface 107 can, for example, include a wired or wireless network device operable to communicate data to and from a network 111. The network 111 can include one or more local area networks (LANs) and/or a wide area network (WAN) such as the Internet. Other architectures can also be used.

The data storage unit 102 may be a hard drive or other computer readable medium known in the art. The reference values may be inputted by any input devices 106 known in the art, including, keyboard, mouse, or other peripherals, voice recognition, optical scanning, etc. Alternatively, the reference values may be implemented automatically. Example output devices 109 include a display device, an audio device, etc.

The reference values pertain to the liquidity profile and capital structure of the bank. In a preferred embodiment, the reference values are quantitative goals concerning a bank's tangible common equity, tangible assets, total amount of loans, and total amount of deposits. The values are preferably expressed as a loan to deposit ratio (L/D) and a tangible common equity to tangible assets ratio (TCE/TA). An L/D ratio is an indicator of a bank's core funding ability and overall liquidity profile. A high ratio of loans to deposits can demonstrate decreased liquidity for a bank's funding needs, which may pose substantial risks to the bank in the event a large amount of funds are suddenly needed to fund an expanding loan portfolio. The TCE/TA ratio is an important capital management metric in evaluating the capitalization of a bank.

In a preferred embodiment, the reference value for the TCE/TA ratio is in a range of approximately 5-11%. For example, the TCE/TA may be expressed as a floor of 8%. The reference value for the L/D ratio is preferably in the range of approximately 60-90%.

The device 100 is adapted so that referenced values stored by the storage unit 102 may be deleted and new reference values may be inputted and stored by the user as needed. The ability to easily change the reference values provides flexibility to the bank. The reference values relating to an optimal liquidity profile and capital structure may be easily changed by the bank to reflect the current financial climate, new regulations, or different strategic objectives. Alternatively, while it is preferable that the reference values are not stored in a permanent manner, in alternative embodiments, the reference values may be permanent and integrated into the programmed instructions of the device 100.

The device 100 has a calculation unit 108 to calculate the bank's current book values of the selected fields for the reference values (step 304). The underlying data concerning these values are received either by automatic means or are manually inputted into the device. For instance, general loan balances may be provided by the bank's general ledger system. The calculation unit 108 is adapted to compute each of the current book values for these fields by using a processor 104. In a preferred embodiment, the resulting output by the calculation unit 108 is the current L/D and TCE/TA of the bank. Alternatively, the computation of these values may be performed without use of the device 100 and the device 100 has means to receive current L/D and TCE/TA values of the bank.

The device 100 has a comparison unit 110 which is adapted to determine the differences between the reference values and the current book values for the bank. The comparison unit 110 can include a processor. The comparison unit 110 then computes the differential values between the reference values and current book values for the bank and transmits the differential values to an allocation unit 114 (step 306).

In a preferred embodiment, the comparison unit 110 also has a trigger unit 112 which signals that a current book value for the bank is not in compliance with the optimal liquidity profile and/or capital structure goals as measured by the referenced values (step 308). If this is the case, at least one trigger signal is transmitted to an allocation unit 114 of the device 100 (step 310); otherwise, no trigger signal is transmitted (step 312). For instance, if there is a positive differential between the actual TCE/TA ratio as compared to the referenced TCE/TA ratio (i.e., the actual TCE/TA ratio is higher than the referenced TCE/TA ratio), the comparison unit 110 analyzes this differential as indicating the current TCE/TA ratio meets the set TCE/TA goal and the trigger unit 112 does not transmit a signal. If there is no difference between the actual TCE/TA ratio and the TCE/TA ratio (i.e., the actual TCE/TA ratio equals the referenced TCE/TA ratio), the comparison unit 110 analyzes this differential as indicating that the current TCE/TA ratio meets the set TCE/TA goal and the trigger unit 112 does not transmit a signal. If there is a negative differential between the actual TCE/TA ratio as compared to the referenced TCE/TA ratio (i.e., the actual TCE/TA ratio is lower than the referenced TCE/TA ratio), the comparison unit 110 analyzes this differential as indicating that the current TCE/TA ratio fails to meet the set TCE/TA goal and the trigger unit 112 transmits a signal to the allocation unit 114.

If the L/D ratio is within the range of the referenced L/D ratio, the comparison unit 110 analyzes this differential as indicating that the current L/D value meets the L/D goal and the trigger unit 112 does not transmit a signal. If the L/D ratio is outside the range of the referenced L/D ratio, the comparison unit 110 analyzes this differential as indicating that the current L/D ratio fails to meet the L/D goal and the trigger unit 112 transmits a signal to the allocation unit 114.

The allocation unit 114 may include a processor that is adapted to receive the differential values and trigger signals and calculate the appropriate amount of funds from the primary account to a second account for maintaining an optimal liquidity profile and/or capital structure for the bank (step 314). The allocation unit 114 follows a programmed algorithm to determine the amount of transfer necessary for maintaining an optimal liquidity profile and/or capital structure. In a preferred embodiment, the allocation unit 114 is adapted so that if there are no trigger signals received, there are no funds allocated for transfer and the on-balance and off-balance funds will remain intact.

If one trigger signal is received indicating L/D is out of compliance with the set goal, the allocation unit 114 uses the differential value for that field and calculates an amount of funds to be transferred so that the value meets the set goal in accordance with the predetermined reference value. However, if the allocation amount necessary to bring L/D into compliance with the set goal will make TCE/TA fall outside its set goal, then the allocation amount will be modified so that the TCE/TA ratio does not fall outside of its set goal, even if L/D is not brought into compliance with its set goal. In contrast, if one trigger signal is received which indicates that TCE/TA is not in compliance with the set goals, the allocation unit 114 uses the differential value for that field and calculates an amount of funds to be transferred so that the value meets the set goal in accordance with the predetermined reference value. The allocation amount will not be modified even if the allocation amount necessary to bring TCE/TA into compliance with the set goal will make L/D fall outside its set goal.

If two trigger signals are received by the allocation unit 114 indicating that both the TCE/TA ratio and L/D ratio are not within the specified goals, the differential values for the two fields is apportioned based on predetermined instructions and an allocation is determined which maximizes the bank's liquidity and capital structure. In a preferred embodiment, if both trigger signals are received by the allocation unit 114, the allocation unit 114 will calculate an allocation amount equal to the differential value for the TCE/TA ratios so that the TCE/TA ratio meets the set goal in accordance with the predetermined reference value. The allocation unit 114 calculates this allocation amount even if it results in the L/D ratio remaining out of compliance with the goals. The allocation unit 114 may then modify the allocation amount so that the L/D ratio meets or comes closer to meeting its goal provided that the TCE/TA value continues to meet its goal.

The allocation algorithm of a preferred embodiment factors TCE/TA as having more importance than the L/D ratio. The allocation algorithm has an adjustment unit whereby the allocation algorithm may be adjusted to reflect the current financial climate, new regulations, or new performance goals. For instance, the allocation algorithm may be adjusted when necessary to weigh L/D more significantly.

In a preferred embodiment, the device 100 also includes a transfer unit 116 to execute the transfer of funds from the primary balance account to the off balance account, or vice versa (step 316). The transfer unit 116 is adapted to receive the allocation amount determined by the allocation unit 114. The transfer unit 116 is adapted to execute the transfer of funds in the exact allocation amount calculated by the allocation unit 114. The transfer unit 116 may execute the transfer of funds by generating paper or electronic transfer orders (or such other transfer means known in the art).

The calculation unit 108, the comparison unit 110, the trigger unit 112, and the allocation unit 114 of the device 100 may be adapted to operate at different times of the day as desired. For example, in one embodiment, the device 100 will calculate the current book values of the selected fields immediately after all daily balance sheet and income statement entries have been made and finalized. In some circumstances this time period may be around midnight. The comparison unit 110, the trigger unit 112, the allocation unit 114, and the transfer unit 116 may then perform their respective operations in a time frame that is sufficient to meet the objectives of the present invention. As an example, if the calculation unit 108 calculates current book values around midnight, the comparison unit 110, the trigger unit 112, and the allocation unit 114 may operate in a time frame sufficient for the transfer unit 116 to execute the transfer of funds between 2 am-5 am. Of course, this is just an example, and the present invention is not limited thereto.

The primary on-balance account is preferably an interest-bearing demand account. In alternative embodiments, the on-balance account may be non-interest-bearing demand accounts. The off-balance account may be a third party money market mutual fund or other financial account products or funds known in the art. While the present invention is described as being used for a sweep account, the device may be used for allocation and transfer of funds between other types of accounts. Furthermore, the device 100 may be adapted to transfer funds to a plurality of off-balance accounts.

Another aspect of the invention is a non-transitory computer-readable medium storing a program which when executed by at least one processor, allocates and transfers funds deposited in a first account to a second account. More specifically, the computer-readable medium may be used in connection with a sweep account to automatically allocate and transfer funds between a primary on-balance demand account and one or more off-balance accounts in a manner which assists the bank in maintaining an optimal liquidity profile and capital structure as described above. Non-limiting examples of computer readable medium in accordance with this invention include magnetic disks, magnetic cards, magnetic tapes, magnetic drums, and optical disks.

Another aspect of the invention is a method for allocating and transferring funds deposited in a first account to a second account. In a preferred embodiment, the method is for allocating and transferring funds in a sweep account between a primary on-balance demand account and one or more off-balance accounts in a manner which assists the bank in maintaining an optimal capital structure and liquidity profile as described above.

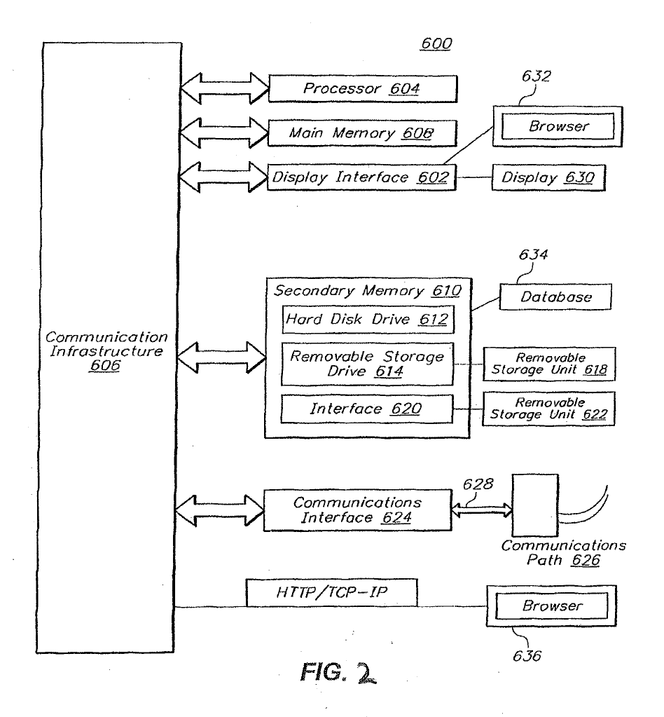

The present invention or any part(s) or function(s) thereof, including the calculation unit 108, the comparison unit 110, the trigger unit 112, the allocation unit 114, and the transfer unit 116, may be implemented using hardware, software or a combination thereof and may be implemented in one or more computer systems or other processing systems. In one embodiment, the invention is directed towards one or more computer systems capable of carrying out the functionality described herein. An example of such a computer system 600 is shown in FIG. 2.

The computer system 600 includes one or more processors, such as processor 604. The processor 604 is connected to a communication infrastructure 606 (e.g., a communications bus, cross-over bar, or network).

Computer system 600 can include a display interface 602 that forwards graphics, text, and other data from the communication infrastructure 606 (or from a frame buffer not shown) for display on the display unit 630. Display interface 602 can communicate with browser 632. Computer system 600 also includes a main memory 608, preferably random access memory (RAM), and may also include a secondary memory 610 and a database 634. The secondary memory 610 may include, for example, a hard disk drive 612 and/or a removable storage drive 614, representing a floppy disk drive, a magnetic tape drive, an optical disk drive, etc. The removable storage drive 614 reads from and/or writes to a removable storage unit 618 in a well known manner. Removable storage unit 618 represents a floppy disk, magnetic tape, optical disk, etc. which is read by and written to by removable storage drive 614. As will be appreciated, the removable storage unit 618 includes a computer usable storage medium having stored therein computer software and/or data.

In alternative embodiments, secondary memory 610 may include other similar devices for allowing computer programs or other instructions to be loaded into computer system 600. Such devices may include, for example, a removable storage unit 622 and an interface 620. Examples of such may include a program cartridge and cartridge interface (such as that found in video game devices), a removable memory chip (such as an erasable programmable read only memory (EPROM), or programmable read only memory (PROM)) and associated socket, and other removable storage units 622 and interfaces 620, which allow software and data to be transferred from the removable storage unit 622 to computer system 600.

Computer system 600 may also include a communications interface 624. Communications interface 624 allows software and data to be transferred between computer system 600 and external devices. Examples of communications interface 624 may include a modem, a network interface (such as an Ethernet card), a communications port, a Personal Computer Memory Card International Association (PCMCIA) slot and card, etc. Software and data transferred via communications interface 624 are in the form of signals 628 which may be electronic, electromagnetic, optical or other signals capable of being received by communications interface 624. These signals 628 are provided to communications interface 624 via a communications path (e.g., channel) 626. This channel 626 carries signals 628 and may be implemented using wire or cable, fiber optics, a telephone line, a cellular link, a radio frequency (RF) link and other communications channels. Browser 636 is connected to communication infrastructure 606.

In this document, the terms “computer program medium” and “computer usable medium” are used to refer generally to media such as removable storage drive 614, a hard disk installed in hard disk drive 612, and signals 628. These computer program products provide software to computer system 600. The invention is directed to such computer program products.

Computer programs (also referred to as computer control logic) are stored in main memory 608 and/or secondary memory 610. Computer programs may also be received via communications interface 624. Such computer programs, when executed, enable the computer system 600 to perform the features of the present invention, as discussed herein. In particular, the computer programs, when executed, enable the processor 604 to perform the features of the present invention. Accordingly, such computer programs represent controllers of the computer system 600.

In an embodiment where the invention is implemented using software, the software may be stored in a computer program product and loaded into computer system 600 using removable storage drive 614, hard drive 612 or communications interface 624. The control logic (software), when executed by the processor 604, causes the processor 604 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s). In yet another embodiment, the invention is implemented using a combination of both hardware and software.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A device for automatically transferring funds deposited in a first bank account of a financial institution to a second account, comprising:
a computer;
software executing on said computer which evaluates the current loan to deposit ratio of the financial institution to a predefined reference ratio and evaluates the current tangible common equity to tangible assets of the financial institution to a predefined reference ratio;
software executing on said computer which automatically calculates a quantity of funds to be transferred from the first bank account to the second bank account by using allocation means which evaluates the differentials between the current loan to deposit ratio and tangible common equity to tangible assets ratio to their respective reference ratios and focuses on maintaining an optimal liquidity profile and capital structure for the financial institution when determining the quantity of funds to be transferred;
said device communicates execution orders to transfer said determined quantity of funds to be transferred.

2. The device for automatically transferring funds in claim 1 wherein said first bank account is a demand account and said second account is an off-balance money market fund.

3. The device for automatically transferring funds in claim 2 wherein said first account is an interest bearing demand account.

4. The device for automatically transferring funds in claim 1 wherein said software transmits separate trigger signals when said tangible common equity to tangible assets ratio does not meet a predefined goal and said loan to deposit ratio does not meet a predefined goal.

5. The device for automatically transferring funds in claim 4 wherein said allocation means allocates funds as follows:
if one trigger signal is received which indicates the L/D ratio does not meet the predefined goal, said allocation means utilizes the L/D differential value and allocates an amount of funds whereby the L/D value will meet the goal after the transfer; however, the allocation amount is modified if it will cause the TCE/TA ratio after transfer to fall outside its set goal, so that the TCE/TA ratio after transfer will meet the TCE/TA goal even if the L/D ratio after transfer does not meet the goal;
if one trigger signal is received which indicates the TCE/TA does not meet the predefined goal, said allocation means utilizes the TCE/TA differential value and allocates an amount of funds whereby the TCE/TA value will meet the goal after the transfer; and
if two trigger signals are received, said allocation means first utilizes the TCE/TA differential value and allocates an amount of funds equal to the differential value for the TCE/TA ratio so that the TCE/TA ratio meets the set goal after the transfer, and the allocation means then modifies the allocation amount so that the L/D ratio meets or comes closer to meeting its goal provided that the TCE/TA value continues to meet its goal.

6. The device for automatically transferring funds in claim 1 wherein said software executing on said computer calculates the financial institution's current book values for tangible common equity, tangible assets, total amount of loans and total amount of deposits and determines the current loan to deposit ratio and current tangible common equity to tangible assets of the financial institution.

7. A method for automatically transferring funds deposited in a first bank account of a financial institution to a second account, implemented on a computer having a processor and a memory coupled to said processor, said method comprising:
evaluating the current loan to deposit ratio of the financial institution to a predefined reference ratio using said processor;
evaluating the current tangible common equity to tangible assets of the financial institution to a predefined reference ratio using said processor;
calculating differentials between the current loan to deposit ratio and tangible common equity to tangible assets ratio to their respective reference ratios using said processor;
allocating a quantity of funds to be transferred from the first bank account to the second bank account by using said processor to evaluate current book values concerning the bank's capital structure and focuses on maintaining an optimal liquidity profile and capital structure for the financial institution when determining the quantity of funds to be transferred; and
communicating execution orders by said processor to transfer said determined quantity of funds to be transferred.

8. A non-transitory computer-readable medium storing a program, which, when executed by at least one processor, causes the at least one processor to perform a method for automatically transferring funds deposited in a first bank account of a financial institution to a second account, said method comprising:
evaluating the current loan to deposit ratio of the financial institution to a predefined reference ratio using said processor;
evaluating the current tangible common equity to tangible assets of the financial institution to a predefined reference ratio using said processor;
calculating differentials between the current loan to deposit ratio and tangible common equity to tangible assets ratio to their respective reference ratios using said processor;
allocating a quantity of funds to be transferred from the first bank account to the second bank account by using said processor to evaluate current book values concerning the bank's capital structure and focuses on maintaining an optimal liquidity profile and capital structure for the financial institution when determining the quantity of funds to be transferred; and
communicating execution orders by said processor to transfer said determined quantity of funds to be transferred.
